(19) United States
(12) Patent Application Publication
(10) Pub. No.: US 2005/0212968 A1
(43) Pub. Date: Sep. 29, 2005

(54) Apparatus and method for synchronously displaying multiple video streams

(76) Inventor: Kim Annon Ryal, Poway, CA (US)

Correspondence Address: CARPENTER & KULAS, LLP, 1900 EMBARCADERO ROAD, SUITE 109, PALO ALTO, CA, 94303, US

(21) Appl. No.: 10/807,900

(22) Filed: Mar. 24, 2004

(51) Int. Cl. H04N 5/45

(52) U.S. Cl. 348/565

(57) ABSTRACT

A method and apparatus for displaying video streams. A pair of video streams are received. One of the video streams is modified to produce a modified video stream, which is displayed along with the other video stream to produce a PIP window having the appearance of a seamless video stream. A machine-readable medium having stored thereon instructions for displaying video streams.

### BACKGROUND OF THE INVENTION

1. Field of Invention

Embodiments of the present invention broadly relate to multiple video program streams. More specifically, embodiments of the present invention provide for an apparatus and method for synchronously displaying multiple video program streams, such as on a display screen.

2. Description of the Background Art

MPEG (Motion Picture Experts Group) employ certain standards for the compression of digital video and audio sequences. The MPEG codecs use lossy data compression using transform codecs. In lossy transform codecs, samples of picture or sound are taken, chopped into small segments, transformed into a ‘frequency’ space, and quantized. The resulting quantized values are then entropy coded. Thus, any MPEG coding standard (e.g., MPEG-1, MPEG-2, etc.) basically comprises synchronizing and multiplexing of video and audio, compressing codec for non-interlaced video signals, and compressing codec for perceptual coding of audio signals. Therefore, any MPEG standard generally defines three “layers,” or levels of complexity, of MPEG audio coding.

MPEG-2 is typically used to encode audio and video for broadcast signals, such as HDTV, interlaced video TV systems, digital satellite and Cable TV. MPEG-2, with some modifications, is also the coding format used by standard commercial DVD movies. MPEG-2 also introduces and defines Transport Streams, which are designed to carry digital video and audio over unreliable media, and are used in broadcast applications.

A MPEG Transport Stream typically comprises a plurality of encoded diverse Program IDs (PIDs) which are transmitted to a PID parser that separates the encoded PIDs into program streams for decoding. After the program streams are decoded, they are transmitted to a display screen (e.g., a TV screen). Many times the display screen will be capable of picture-in-picture (PIP), permitting simultaneous display of two or more decoded program streams in a main and PIP window. Unfortunately, one decoded displayed PID in the main window may contain video elements that obscure an important section of the displayed video. By way of example, a displayed score board in the upper left hand corner of a TV screen may obscure critical parts of a game being watched on the remaining portion of the TV screen. Therefore, it would be desirable to be able to remove from a display screen those video elements in a decoded displayed PID stream which is partly blocking the viewing of other portions of this decoded displayed PID stream.

### SUMMARY OF EMBODIMENTS OF THE INVENTION

Embodiments of the present invention provide a method for displaying video streams comprising providing a video stream, modifying the video stream to produce a modified video stream, and displaying (e.g., on a TV screen or a computer screen) the video stream along with the modified video stream, preferably after the video stream and the modified video stream have been synchronized, to produce a PIP window having the perception of a single video stream (i.e., a seamless video stream). By displaying the modified video stream as a PIP window, and synchronizing its display and position with the video stream, the PIP window will overlay a small window of the modified video stream and have the appearance of a single video stream. Modifying the video stream may comprise duplicating the video stream and removing or adding at least one video element from or to the video stream to produce a modified duplicated video stream. If at least one video element is removed from the duplicated video stream and the duplicated video stream is then overlayed and synchronized with the video stream, the removed video element allows a viewer to see more of the video stream after the overlay and synchronization with the modified duplicated video stream. If at least one video element is added to the duplicated video stream and the duplicated video stream is then overlayed and synchronized with the video stream, the added video element allows a viewer to see more of the video stream after the overlay and synchronization with the modified duplicated video stream. Thus, the adding or removal of a video element from the duplicated video stream, followed by the overlaying and synchronization with the video stream, allows a viewer to see more of the video stream than if the video stream had not been duplicated, modified (e.g., adding or removal of a video element), overlayed and synchronized with the video stream.

The method for displaying video streams may additionally comprise displaying the PIP window of the modified, displayed video stream and/or designating the location of the modified, duplicated video stream within the PIP window, and the location of the PIP window within the main window, preferably by providing in the modified, duplicated video stream information that determines the location within the PIP window of the modified, duplicated video stream and the location of the PIP window within the main window. As indicated, the modified, duplicated video stream is preferably synchronized with the video stream (i.e., the main video stream). By controlling the PIP (i.e., the location of the display of the modified, duplicated video stream and/or the location of the modified, duplicated video stream within the main video stream) and synchronizing the modified, duplicated video stream with the main video stream, a video stream is produced which has the perception or appearance to a viewer of a single video stream (i.e., a seamless video stream).

Embodiments of the present invention further provide a machine-readable medium having stored thereon instructions for: receiving a first video stream, receiving a second video stream comprising a modified first video stream, and displaying the first video stream along with the second video stream on a display screen. The displaying on the display screen of the modified video stream produces a PIP window having the perception of a single video stream.

Embodiments of the present invention also provide an apparatus for displaying video streams comprising means for receiving a first video stream, means for receiving a second video stream including a modified first video stream, means for displaying the first video stream on a display screen, and means for displaying on the display screen the modified video stream to produce a PIP window having the perception of a single video stream.

Further embodiments of the present invention provide an apparatus for displaying video streams comprising a receiver for receiving a first video stream and a modified video stream, and a display screen for displaying the first video stream and the modified video stream to produce a PIP video stream having the perception of a single video stream.

Further embodiments of the present invention also provide a display screen comprising a displayed first video stream, and a displayed modified video stream to produce a PIP window having the perception of a single video stream. The modified video stream had been produced by modifying (e.g., removing from or adding at least one video element to) the first video stream.

These provisions together with the various ancillary provisions and features which will become apparent to those artisans possessing skill in the art as the following description proceeds are attained by devices, assemblies, systems and methods of embodiments of the present invention, various embodiments thereof being shown with reference to the accompanying drawings, by way of example only, wherein:

### BRIEF DESCRIPTION OF THE DRAWINGS

FIG. 1 is a schematic diagram of a prior art MPEG assembly for processing a video/audio transport stream from a data channel.

FIG. 2 is a schematic diagram of a prior art MPEG processor assembly for processing multiple video/audio transport streams through a Transport Stream Parser.

FIG. 3 is a flow diagram for transporting a plurality of MPEG Transport Streams and for displaying the Transport Streams on a display screen after the Transport Streams have passed through a parser and have been decoded.

FIG. 4 is a schematic diagram of a MPEG assembly for processing multiple video/audio transport streams in accordance with embodiments of the present invention.

FIG. 5 is a display screen having a main video Program ID stream (e.g., PID A stream).

FIG. 6 is the display screen of FIG. 5 after removal of the video elements (e.g., a scoreboard) which was partly masking the main video Program ID stream (e.g., PID A stream).

FIG. 7 is a display screen of a PIP window having a main video Program ID stream (e.g., PID A stream) being partly masked by video elements within the stream.

FIG. 8 is the display screen of FIG. 7 after partly removal of the video elements (e.g., scoreboard) which was partly masking the main video Program ID stream (e.g., PID A stream).

FIG. 9 is a display screen showing a main video Program ID stream having an objectionable video element on one of the persons, and an acceptable video element after modification of the main video Program ID stream.

FIG. 10 is the main video Program ID stream being displayed after removal of the objectionable video element by overlaying and synchronizing the acceptable video element over the objectionable video element.

FIG. 11 shows the return of the main video Program ID stream after a person originally having the objectionable video element has moved such that the objectionable video element can not be seen.

### DETAILED DESCRIPTION OF EMBODIMENTS OF THE INVENTION

In the description herein for embodiments of the present invention, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

A “set-top box” (STB) for various embodiments of the present invention may be any electronic device designed to produce output on a conventional television set (on top of which it nominally sits) and connected to some other communications channels such as telephone, ISDN, or optical fiber cable. The STB usually runs software to allow the user to interact with the programs shown on the television in some way. The STB may function with any suitable apparatus which is capable of producing and/or transmitting a video transport stream (e.g., a MPEG stream), such as a computer, a camera, or any combination of a TV, a computer, and a camera. Thus, the method for synchronously displaying multiple video program ID streams, such as on a display screen, for embodiments of the present invention would be applicable for any electronic device (e.g., a STB) communicatively functioning with any suitable video receiving apparatus designed to produce or display video output (e.g., a television set, a computer, etc).

A “computer” for purposes of embodiments of the present invention may be any processor-containing device, such as a mainframe computer, a personal computer, a laptop, a notebook, a microcomputer, a server, or any of the like. A “computer program” may be any suitable program or sequence of coded instructions which are to be inserted into a computer, well know to those skilled in the art. Stated more specifically, a computer program is an organized list of instructions that, when executed, causes the computer to behave in a predetermined manner. A computer program contains a list of ingredients (called variables) and a list of directions (called statements) that tell the computer what to do with the variables. The variables may represent numeric data, text, or graphical images. If a computer is employed for synchronously displaying multiple video program ID streams, such as on a display screen of the computer, the computer would have suitable instructions (e.g., source code) for allowing a user to synchronously display multiple video program ID streams in accordance with the embodiments of the present invention.

A “computer-readable medium” for purposes of embodiments of the present invention may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory. The computer readable medium may have suitable instructions for synchronously displaying multiple video program ID streams, such as on a display screen, in accordance with various embodiments of the present invention.

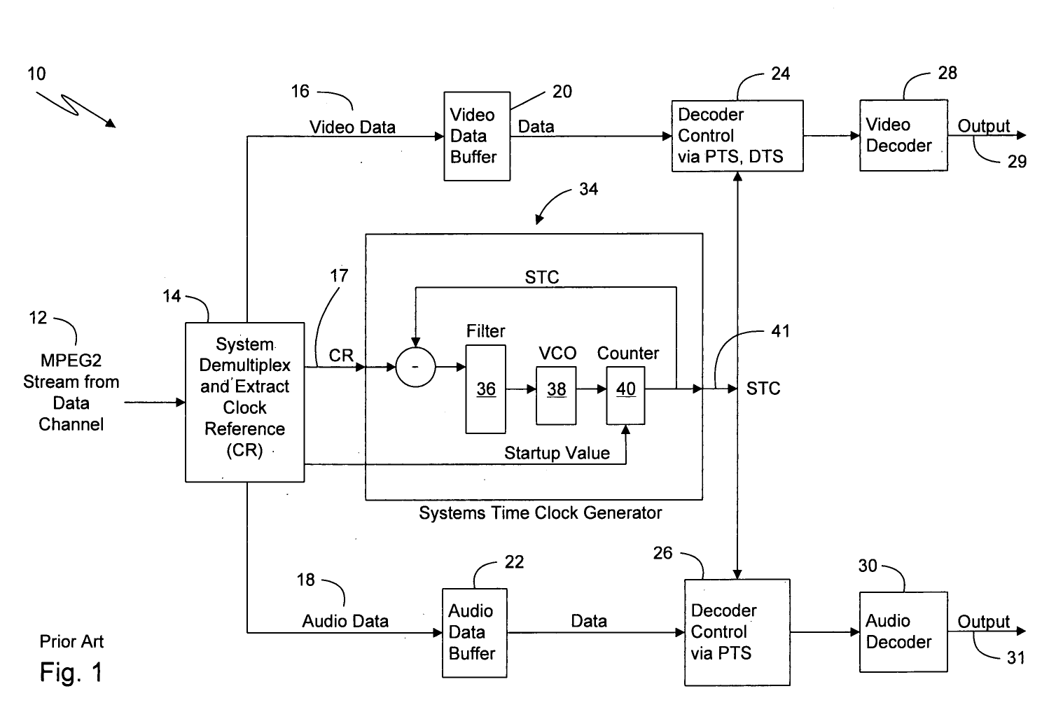

Referring now to FIG. 1, there is seen a schematic diagram of a prior art MPEG assembly, generally illustrated as 10, for processing a video/audio transport stream from a data channel. A MPEG2 video/audio transport stream 12 enters a system demultiplexer and extract clock reference, generally illustrated as 14, where the transport stream 12 is separated into video data 16, clock reference data 17, and audio data 18. Video data 16 passes through a video data buffer 20, a decoder control 24 via program transport stream (PTS), and a video decoder 28 to produce video output 29 which is to be displayed on any suitable display screen (e.g., a computer screen, a TV screen, etc). Audio data 18 passes through an audio data buffer 22, a decoder control 26 via program transport stream (PTS), and an audio decoder 30 to produce audio output 31 which is to be heard simultaneously with the video output 29 being displayed on any suitable display screen (e.g., a computer screen, a TV screen, etc). The clock reference data 17 passes into a system clock generator, generally illustrated as 34, having a filter 36, a voltage control oscillator (VCO) 38, and a counter 40, in order to produce system time clock data 41 which communicatively cooperates with decoder controls 24 and 26 to synchronize video output 29 with audio output 31.

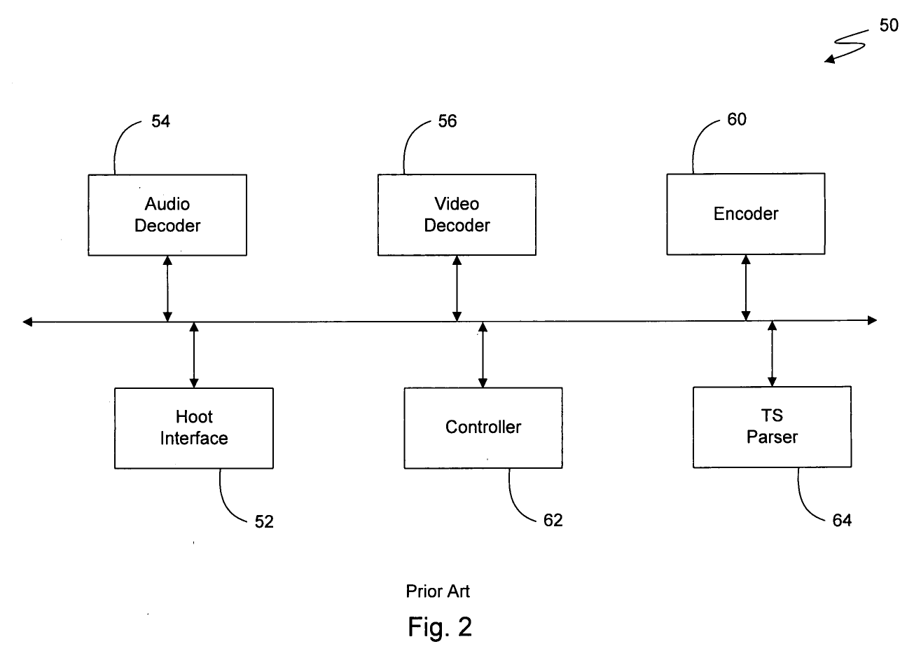

Referring now to FIG. 2, there is seen a schematic diagram of a prior art MPEG processor assembly, generally illustrated as 50, for processing multiple video/audio transport streams through a Transport Stream (TS) Parser 64. In addition to the TS Parser 64, the MPEG includes host interface 52, an audio decoder 54, a video decoder 56, an encoder 60, and a controller 62. The MPEG assemblies of FIGS. 1 and 2, or segments thereof, may be employed to process a plurality of transport streams.

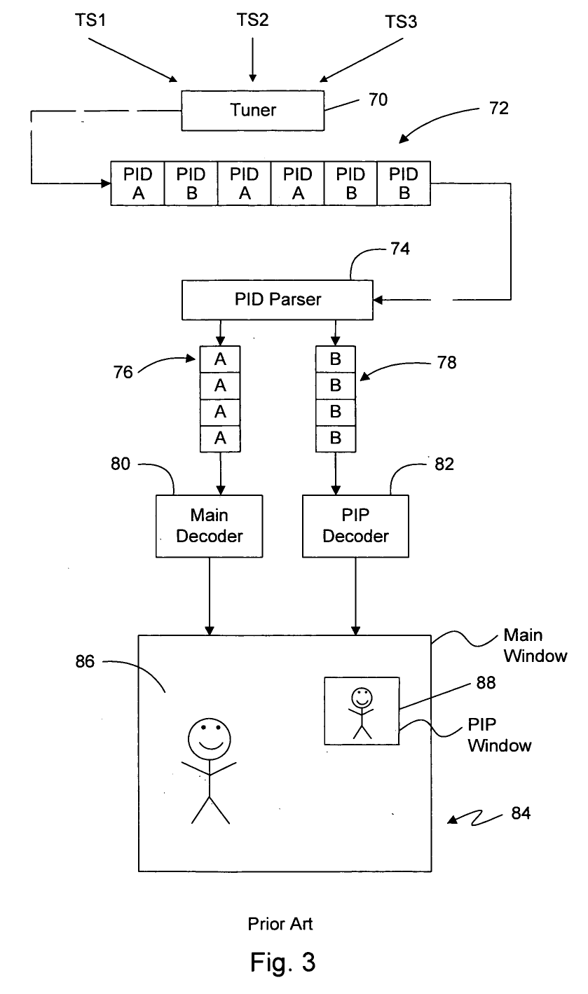

Referring now to FIG. 3, there is seen a prior art schematic flow diagram for transporting a plurality of MPEG Transport Streams TS 1, TS 2, and TS 3 and for displaying the Transport Streams on a display screen after the Transport Streams have passed through a parser and have been decoded. More specifically, each of the Transport Streams TS 1, TS 2, and TS 3 include packets with different PIDs (Program IDs). Transport Streams TS 1, TS 2, and TS 3 pass to a tuner 70 that selects a Transport Stream (e.g., TS 1) having packets, generally illustrated as 72, with PID A and PID B. The selected Transport Stream is transmitted to a PID parser 74 for separating PID A from PID B to respectively produce Program Stream (PS) A, generally illustrated as 76, and Program Stream (PS) B, generally illustrated as 78, both of which are subsequently sent to a decoder 80 and a decoder 82 which decodes PS A and B for display on a display screen, generally illustrated as 84. Decoder 80 comprises a main decoder for decoding PS A to produce a display on main window 86. Decoder 82 includes a PIP decoder for decoding PS B to produce a PIP display 88 on the display of the main window 86.

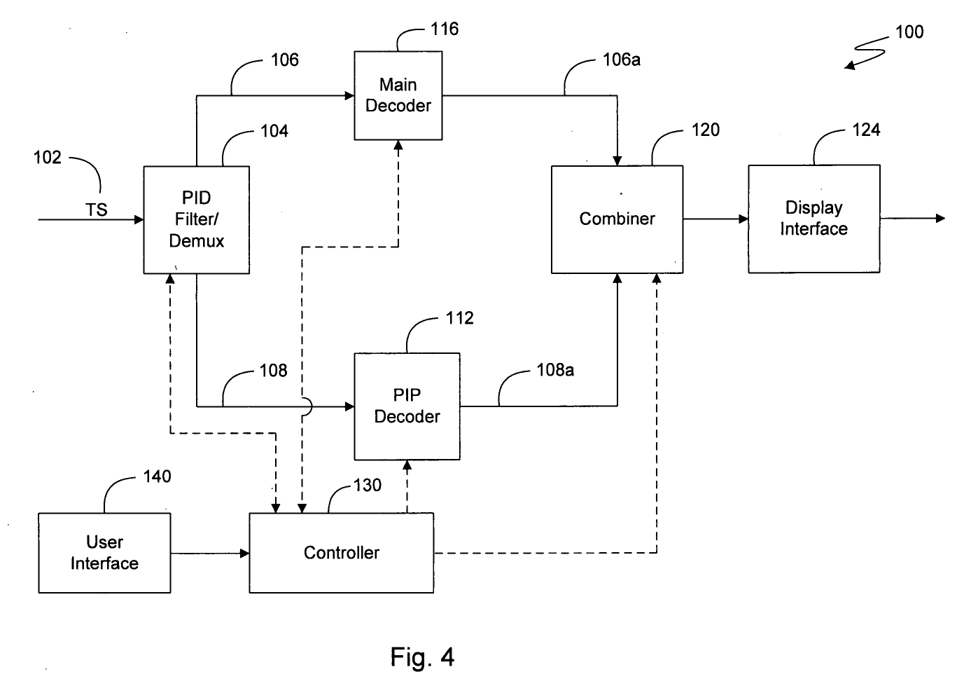

FIG. 4 is a schematic diagram of a MPEG assembly (e.g., a set-top box (STB)) for processing multiple video/audio transport streams in accordance with embodiments of the present invention. In FIG. 4 there is seen transport stream 102 which comprises numerous program streams, such as program streams including video, audio, PCR, and data. The transport stream 102 enters into a PID filter/demux (i.e., a parser) 104 where PIP programs streams 108 are separated from main program streams 106. PIP programs streams 108 and main program streams 106 are respectively transmitted to PIP decoder 112 and main decoder 116 for decoding purposes to produce decoded main program stream 106a and decoded PIP program stream 108a. Typically, as suggested in the description of FIG. 1, PIP program streams 108 and main program stream 106 would respectively pass through internal memory buffer(s) (not shown) before being decoded. Decoded main program stream 106a and decoded PIP program stream 108a pass into combiner 120 where the decoded main program stream 106a and decoded PIP program stream 108a are combined and positioned for being displayed via display interface 124 on a display screen. The combined and positioned decoded PIP program stream 108a and decoded main program stream 106a when displayed have the appearance to a viewer of a single video stream.

A controller 130 (e.g., a CPU with ROM/RAM) is in communication with the PID filter/demux 104, the main decoder 116, the PIP decoder 112 and the combiner 120. The controller 130 receives instructions from a user via a user interface 140 and/or from the MPEG program stream (i.e., the particular program in the transport stream 102) having private data which may be any suitable data that would allow the controller 130 to modify any program from the transport stream including PIP program stream 108 and/or main program stream 106. Private data within the MPEG stream includes data PID which may be employed to send graphic information, or program guide information, or any other information. Graphic data in private data of a MPEG stream (i.e., a main program video for displaying) allows overlying graphics on the display (e.g., PID A illustrated in FIG. 3 and in FIG. 4) to enhance or mask portions of the display.

Continuing to refer to FIG. 4 for illustrating an embodiment of the invention, TS 102 comprises a video stream (e.g., the main program stream 106), and a modified video stream (e.g., PIP stream 108). The modified video stream may be produced by duplicating video stream and subsequently modifying the duplicated video stream. Modification of the duplicated video stream typically occurs at the studio where the video steam originates. Modification may include the adding or removal of a video element (e.g., a scoreboard) to or from the duplicated video program ID stream. When the simultaneously transmitted video stream and modified video stream reaches PID Filter/Demux 104 they are separated into video program stream 106 (i.e., the main program stream 106) and modified video stream 108 (i.e., PIP Program stream 108). The video stream 106 and modified video stream 108 are respectively decoded by main decoder 106 and PIP decoder 112 to produce decoded video stream 106a (i.e., decoded main program video stream 106a) and decoded modified video stream 108a (i.e., decoded PIP video stream 108a), both of which are superimposed or overlayed onto each other. The controller 130 may synchronize the overlayed decoded video stream 106a and decoded modified video stream 108a for display via display interface 124 on a display screen.

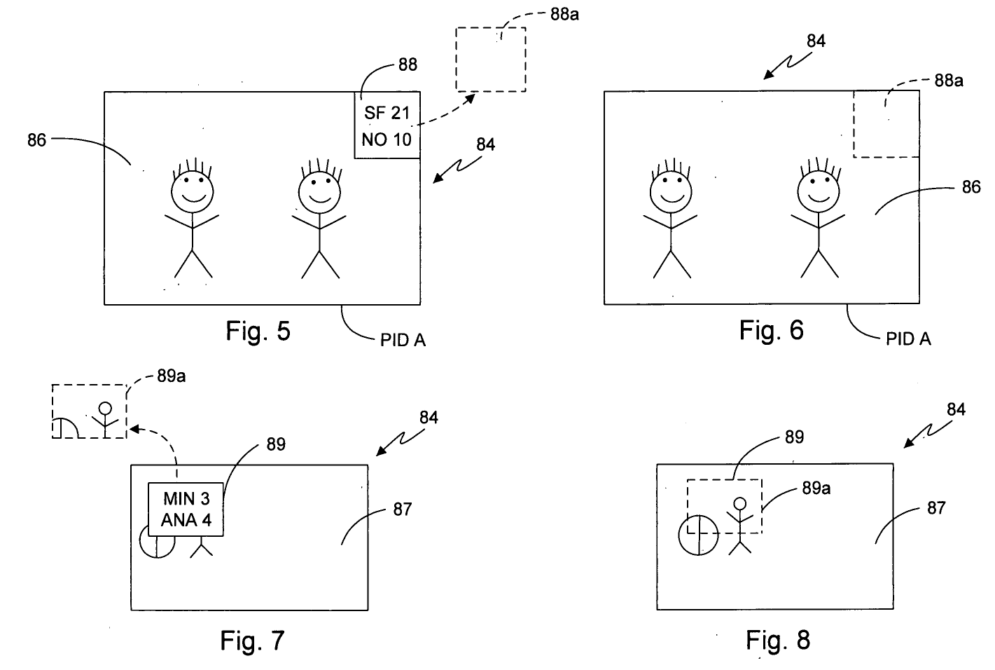

If modified video program stream 108 includes a video element which has been removed from the video stream 106, when the modified video stream 108 is subsequently overlayed and synchronized with the main video stream 106, a viewer will see more of the main video stream 106. Referring now to FIGS. 5 and 6 for illustrating that removal of a video element allows a viewer to see more of the main video stream 106, there is seen in FIG. 5 a display screen 84 showing the main video stream 106 having a scoreboard 88 as a video element and a video element 88a after modification of main video stream 106. In FIG. 6 there is seen the main video stream 106 being displayed after removal of the score board 88 by overlaying and synchronizing video element 88a over the scoreboard 88, the offending video element. Thus, the scoreboard 88 was removed in accordance with the following procedure: (i) main video stream 106 was duplicated; (ii) the duplicated main video stream 106 was modified to produce video element 88a; and (iii) subsequently the video element 88a was synchronized and overlayed over the scoreboard 88. Therefore, main video stream 106 was modified and the modification was transmitted as a separate video stream for overlaying the scoreboard 88 (i.e., the offending video element) in the main video stream 106 to produce a PIP window without the scoreboard 88. As indicated, by controlling the PIP (i.e., the location of the display of the modified, duplicated video stream 108 and/or the location of the modified, duplicated video stream 108 within the main video stream 106) and synchronizing the modified, duplicated video stream 108 with the main video stream 106, a video stream is produced which has the perception or appearance to a viewer of a single (seamless) video stream, as illustrated in FIG. 6.

Referencing now FIGS. 7 and 8 for illustrating another example of removal of a video element to allow a viewer to see more of the video program ID stream 106, there is seen in FIG. 7 the display screen 84 showing the video program ID stream 106 having the scoreboard 89 as the offending video element to be removed. Also illustrated in FIG. 7 is video element 89a after modification of video ID stream 106. In FIG. 8 there is seen the video Program ID stream 106 being displayed after removal of the score board 89 by overlaying and synchronizing video element 89a over the scoreboard 89. Thus, the scoreboard 89 was removed by synchronizing and overlaying over the scoreboard 89 the modified video ID stream 108 (i.e., the video element 89a) to produce a PIP window without the scoreboard 89. Thus, video elements may be removed by replacing them with alternate video elements.

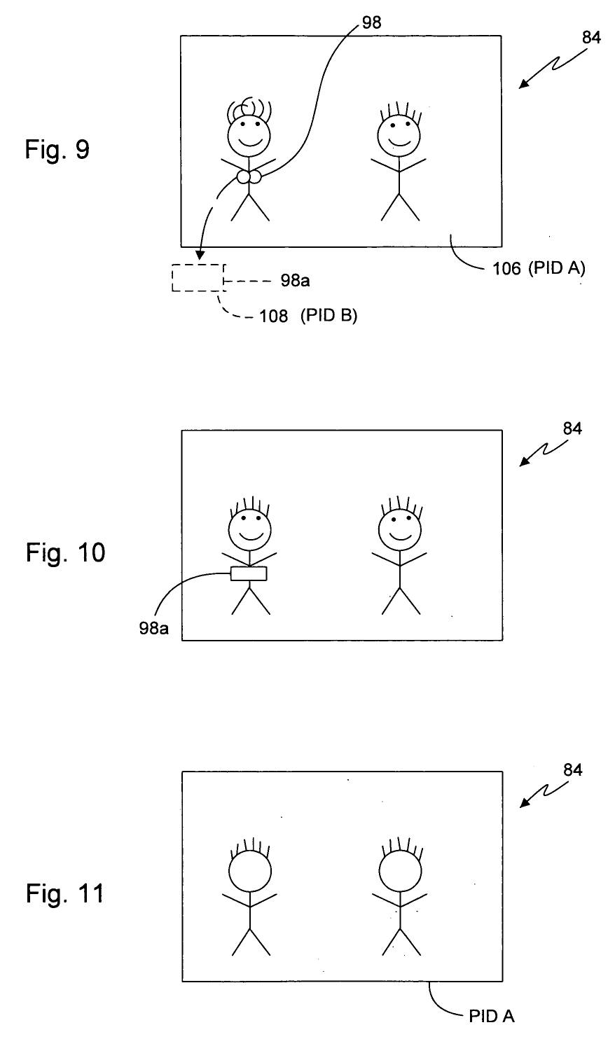

Referring now to FIGS. 9-11 for another embodiment of the present invention, there is seen in FIG. 9 a display screen 84 showing the video stream 106 having an objectionable video element 98 on one of the persons, and a video element 98a after modification of video stream 106. In FIG. 10 there is seen the video stream 106 being displayed after removal of the objectionable video element 98 by overlaying and synchronizing video element 98a over the objectionable video element 98, the offending video element. Therefore, video stream 106 (i.e., PID A) was modified and the modification was transmitted as a separate video stream 108 (i.e., PID B) for overlaying the objectionable video element 98 (i.e., the offending video element) in the video stream 106 to produce a PIP window without the objectionable video element 98. Modified video stream 108 may contain information (e.g., in the MPEG private data field, or in the line 21 data) on where to place the PIP, when to activate the PIP, and when to return and show on the display screen 84 the video stream 106. In FIG. 11 there is shown video stream 106, but with the backs of the people being shown so the objectionable video element 98 can not be seen. Thus, as previously indicated, while video elements may be removed by replacing them with alternate video elements, offending video elements may be removed by adding video elements (i.e., pixilating over the tops of offending video elements). More particularly, a PG version of FIGS. 9-11 may have the “offending elements” removed by pixilating over their associated tops or faces. In the modified video, the “offending elements” would be on full display and when overlayed would be in full view, such as in the offending version.

It is to be understood as indicated, that the graphic data in line 21 of PID A may also be carried in PID B, and a MPEG splice message permits automatically switching between PIDs. However, dual carriage of PID A and PID B may consume a large bandwidth. Thus, for various embodiments of the invention, PID B preferably comprises a small portion of the full video and information or direction on where to dispose PID B within a PIP.

The controller 130 has the capabilities of synchronizing the display of the modified program with the unmodified program. The controller 130 also has the capabilities of designating the location of the displayed PIP window within the main display.

It is to be understood that while FIG. 4 is a schematic diagram of a MPEG assembly (e.g., a set-top box (STB)) for processing multiple video/audio transport streams in accordance with embodiments of the present invention, the spirit and scope of the present invention includes any suitable device, such as a computer, having the capabilities for processing multiple video/audio transport streams in accordance with embodiments of the present invention. It is to be noted that PID filters, MPEG decoders, and combiners are usually implemented in hardware, and there is no reason in a computer implementation that these could not be done in software. It is to be further understood that the video streams do not have to be MPEG streams with transport headers (PIDs), but may be received from the internet, or any other suitable source.

By practice of embodiments of the present invention, first and second video streams are displayed. The first video steam is displayed in the main window and contains video elements (in the video, but not necessarily in any graphics data including line 21 data) that obscures something in the background or is objectionable (e.g., in the case of parental controls). The second video stream is a modified first video stream which is done at the studio and comprises only the window of the video element to be replaced in the first video stream in order to remove the obscuring feature or to obscure/replace the objectionable material. By displaying the second video stream (i.e., the modified first video stream) as a PIP window, and synchronizing its display and position with the first video stream, the PIP window will overlay a small window of the first video stream. Essentially, this PIP window is invisible. It blends with the remainder of the first video stream, giving the viewer the perception that they are watching a single (modified) video.

By further practice of embodiments of the present invention, there is provided a machine-readable medium having stored thereon instructions for performing any of the video tracking and video managing functions for embodiments of the present invention. By way of example only, the machine-readable medium may comprise instructions for: receiving a first video Program ID stream, modifying a second video Program ID stream to produce a modified video Program ID stream, displaying the first video Program ID stream on a display screen, and displaying on the display screen the modified video Program ID stream to produce a PIP window.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Further, at least some of the components of an embodiment of the invention may be implemented by using a programmed general purpose digital computer, by using application specific integrated circuits, programmable logic devices, or field programmable gate arrays, or by using a network of interconnected components and circuits. Connections may be wired, wireless, by modem, and the like.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”; and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

1. A method for displaying video streams comprising:
providing a video stream;
duplicating the video stream to produce a duplicated video stream;
modifying the duplicated video stream to produce a modified video stream; and
displaying on a display screen the video stream along with the modified video stream to produce a PIP window having the appearance of a seamless video stream.

2. The method of claim 1 additionally comprising overlaying, prior to displaying, the modified video Program ID stream onto the video Program ID stream.

3. The method of claim 1 additionally comprising designating the location of the modified video Program ID stream within the PIP window.

4. The method of claim 1 additionally comprising positioning the PIP window within the display screen.

5. The method of claim 4 wherein said designating the location of the modified video stream comprises providing the modified video stream with information which determines the location within the PIP window of the modified video stream relative to the video stream.

6. The method of claim 1 additionally comprising synchronizing the modified video stream with the video stream.

7. The method of claim 2 additionally comprising synchronizing, prior to displaying, the modified video stream with the video stream.

8. The method of claim 1 wherein said display screen comprises a TV screen.

9. The method of claim 1 wherein said display screen comprises a computer screen.

10. The method of claim 1 wherein said modifying the duplicated video stream comprises removing at least one video element from the duplicated video stream.

11. The method of claim 10 wherein said removed at least one video element from the duplicated video stream allows a viewer to see more of the video stream.

12. The method of claim 1 wherein said modifying the duplicated video stream comprises adding at least one video element to the duplicated video stream.

13. The method of claim 12 wherein said added at least one video element to the duplicated video stream allows a viewer to see more of the video stream.

14. A machine-readable medium having stored thereon instructions for:
receiving a first video stream;
receiving a modified video stream; and
displaying on a display screen the first video stream along with the modified video stream to produce a PIP window having the appearance of a seamless video stream.

15. An apparatus for displaying video streams comprising:
means for receiving a first video stream;
means for receiving a second video stream comprising a modified first video stream;
means for displaying the first video stream on a display screen; and
means for displaying on the display screen the modified video stream to produce a PIP window having the appearance of a seamless video stream.

16. An apparatus for displaying video streams comprising:
a receiver for receiving a first video stream and a modified video stream; and
a display screen for displaying the first video stream and the modified video stream.

17. A display screen comprising a displayed first video stream; and a displayed modified video stream to produce a PIP window, wherein said modified video stream having been produced by modifying the first video stream.

18. The display screen of claim 17 wherein said modified video stream having been produced by removing at least one video element from the first video stream.

19. The display screen of claim 17 wherein said modified video stream having been produced by adding at least one video element to the first video stream.
